(19) United States
(12) Patent Application Publication
(10) Pub. No.: US 2022/0181069 A1
(43) Pub. Date: Jun. 9, 2022

(54) TRANSFORMER ELEMENT

(71) Applicant: Mitsubishi Electric Corporation, Tokyo (JP)

(72) Inventors: Yasuo YAMAGUCHI, Tokyo (JP); Manabu YOSHINO, Tokyo (JP); Toshihiro IMASAKA, Tokyo (JP); Yohei TORII, Tokyo (JP)

(73) Assignee: Mitsubishi Electric Corporation, Tokyo (JP)

(21) Appl. No.: 17/472,893

(22) Filed: Sep. 13, 2021

(30) Foreign Application Priority Data
Dec. 4, 2020 (JP) 2020-201489

(51) Int. Cl. H01F 27/28; H01F 27/32

(52) U.S. Cl. CPC H01F 27/2804; H01F 2027/2809; H01F 27/323

(57) ABSTRACT

A transformer element includes: a primary coil including a plurality of primary partial coils having a central axis located on one straight line in an in-plane direction of an insulating film; and a secondary coil including a plurality of secondary partial coils arranged within the insulating film and having a central axis located on the one straight line. One or more of the primary partial coils are each interposed between a pair of the secondary partial coils, or one or more of the secondary partial coils are each interposed between a pair of the primary partial coils in plan view.

### BACKGROUND OF THE INVENTION

### Field of the Invention

The present disclosure relates to transformer elements.

### Description of the Background Art

A microtransformer element including a primary coil for transmission and a secondary coil for reception arranged within an insulating film on a semiconductor substrate has recently been proposed as a transformer element (e.g., Japanese Patent No. 6386005).

It is necessary to increase mutual inductance between the primary coil and the secondary coil to increase signal transmission characteristics from the primary coil to the secondary coil. The mutual inductance is proportional to the number of turns and the cross-sectional area of each of the primary coil and the secondary coil, and is inversely proportional to the distance between the primary coil and the secondary coil.

An increase in number of turns and cross-sectional area to increase signal transmission characteristics, however, causes a problem in that each of the coils increases in size to increase the size of the microtransformer element and a chip size.

### SUMMARY

The present disclosure has been conceived in view of a problem as described above, and it is an object to provide technology enabling reduction in size of a transformer element.

A transformer element according to the present disclosure includes: a substrate; an insulating film disposed on the substrate; a primary coil including a plurality of primary partial coils arranged within the insulating film and having a central axis located on one straight line in an in-plane direction of the insulating film; and a secondary coil including a plurality of secondary partial coils arranged within the insulating film and having a central axis located on the one straight line, wherein one or more of the primary partial coils are each interposed between a pair of the secondary partial coils, or one or more of the secondary partial coils are each interposed between a pair of the primary partial coils in plan view.

The transformer element can be reduced in size.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic perspective view illustrating a configuration of a microtransformer element according to Embodiment 1;

FIG. 2 is a plan view illustrating a configuration of the microtransformer element according to Embodiment 1;

FIG. 3 is a schematic view representing the function of the microtransformer element according to Embodiment 1;

FIG. 4 is a plan view illustrating a configuration of a related microtransformer element;

FIG. 5 is a schematic perspective view for illustrating a method for manufacturing the microtransformer element according to Embodiment 1;

FIG. 6 is a schematic perspective view for illustrating the method for manufacturing the microtransformer element according to Embodiment 1;

FIG. 7 is a schematic perspective view for illustrating the method for manufacturing the microtransformer element according to Embodiment 1;

FIG. 8 is a schematic perspective view for illustrating the method for manufacturing the microtransformer element according to Embodiment 1;

FIG. 9 is a schematic perspective view for illustrating the method for manufacturing the microtransformer element according to Embodiment 1;

FIG. 10 is a schematic perspective view for illustrating the method for manufacturing the microtransformer element according to Embodiment 1;

FIG. 11 is a plan view illustrating a configuration of a microtransformer element according to Modification 1;

FIG. 12 is a cross-sectional view illustrating a configuration of the microtransformer element according to Modification 1;

FIG. 13 is a plan view illustrating a configuration of another microtransformer element according to Modification 1; and

FIG. 14 is a cross-sectional view illustrating a configuration of the other microtransformer element according to Modification 1.

### DESCRIPTION OF THE PREFERRED EMBODIMENTS

Embodiments will be described below with reference the accompanying drawings. Features described in each of the embodiments below are examples, and all the features are not necessary features. In description made below, components similar in a plurality of embodiments bear the same or similar reference signs, and description is made mainly on a different component. In description made below, specific locations and directions indicated by “upper”, “lower”, “left”, “right”, “front”, “back”, and the like do not necessarily match directions in actual use.

### Embodiment 1

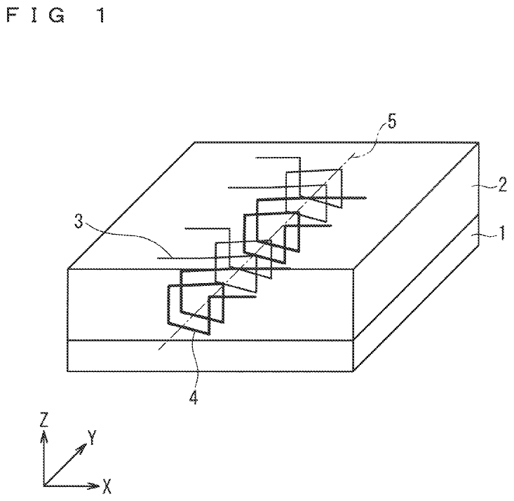

FIG. 1 is a schematic perspective view illustrating a configuration of a microtransformer element as a transformer element according to Embodiment 1. An XYZ Cartesian coordinate axis is shown in drawings including FIG. 1 for convenience of description.

The microtransformer element includes a substrate 1, an insulating film (insulating layer) 2, a primary coil 3, and a secondary coil 4.

The substrate 1 may be a semiconductor substrate on which a semiconductor device has been disposed or an insulating substrate. The semiconductor substrate may be a substrate of a typical semiconductor, such as Si (silicon), or a substrate of a wide bandgap semiconductor, such as SiC (silicon carbide), GaN (gallium nitride), and diamond. When the substrate 1 is the substrate of the wide bandgap semiconductor, the substrate 1 allows for stable operation of the semiconductor device having been disposed on the substrate at an elevated temperature and a high voltage as well as faster switching. The semiconductor device may be an insulated gate bipolar transistor (IGBT), a metal oxide semiconductor field effect transistor (MOSFET), a PN junction diode (PND), a Schottky barrier diode (SBD), a free wheeling diode (FWD), and the like, for example. The insulating substrate may be a substrate of glass, ceramic, and the like, for example.

The insulating film 2 is disposed on the substrate 1. At least a portion of the primary coil 3 and at least a portion of the secondary coil 4 are arranged within the insulating film 2. The primary coil 3 is shown in thin solid lines, and the secondary coil 4 is shown in thick solid lines in FIG. 1 for convenience.

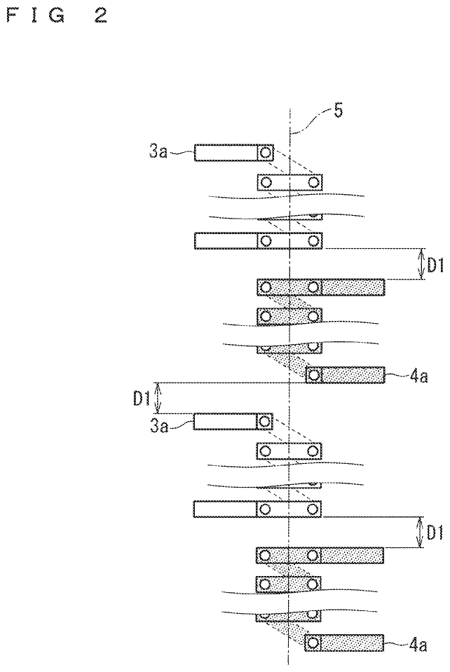

FIG. 2 is a top plan view of the microtransformer element according to Embodiment 1. Only components of the primary coil 3 and the secondary coil 4 are illustrated in FIG. 2 for convenience.

The primary coil 3 includes a plurality of primary partial coils 3a arranged within the insulating film 2 and electrically connected to each other. As illustrated in FIGS. 1 and 2, the plurality of primary partial coils 3a are each a conductive winding having been wound around a central axis one or more times.

A helical portion corresponding to a single turn of each of the primary partial coils 3a includes two line portions parallel to an in-plane direction of the insulating film 2 and two line portions perpendicular to the in-plane direction of the insulating film 2, and each of the primary partial coils 3a is quadrilateral as viewed from the central axis. Each of the primary partial coils 3a is not required to have this shape, and may have a polygonal shape other than the quadrilateral shape as viewed from the central axis, for example. One or more helical portions as described above are connected along the central axis to constitute a single primary partial coil 3a.

In Embodiment 1, the central axis of the plurality of primary partial coils 3a is located on one straight line 5 in the in-plane direction of the insulating film 2 as illustrated in FIG. 2. The in-plane direction of the insulating film 2 herein is substantially the same as an in-plane direction of the substrate 1.

The secondary coil 4 has a similar configuration to the primary coil 3. That is to say, the secondary coil 4 includes a plurality of secondary partial coils 4a arranged within the insulating film 2, and the central axis of the plurality of secondary partial coils 4a is located on the above-mentioned one straight line 5. In Embodiment 1 having such a configuration, the central axis of the plurality of primary partial coils 3a and the central axis of the plurality of secondary partial coils 4a are located on the one straight line 5. Furthermore, in Embodiment 1, one or more of the primary partial coils 3a are each interposed between a pair of the secondary partial coils 4a, and one or more of the secondary partial coils 4a are each interposed between a pair of the primary partial coils 3a in plan view.

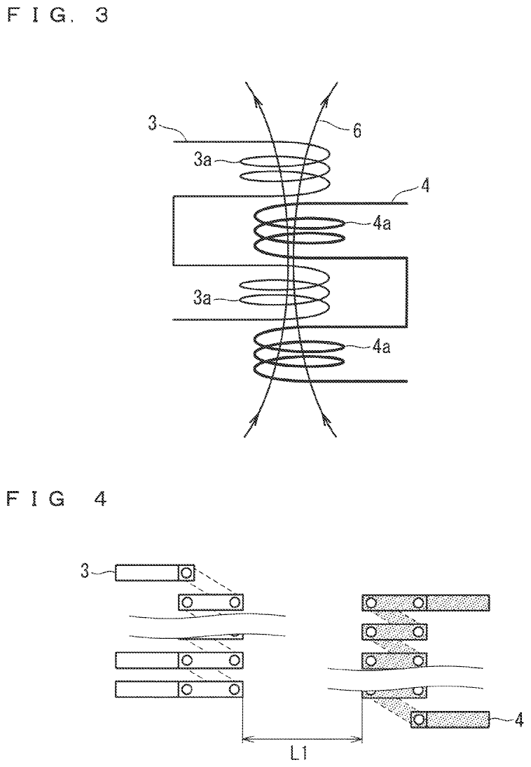

FIG. 3 is a schematic view representing the function of the microtransformer element according to Embodiment 1. Magnetic flux 6 is generated in the primary coil 3 when a current flows through the primary coil 3, and a current flows through the secondary coil 4 when the magnetic flux 6 passes through the secondary coil 4. That is to say, a change in current through the primary coil 3 is transmitted to the secondary coil 4. The magnitude of the current flowing through the secondary coil 4 is determined by mutual inductance represented by the following equations (1) to (3):

$$\begin{matrix}[ Math . 1 ] & \\ M = k \times \sqrt{L a \times L b} & ( 1 ) \\ [ Math . 2 ] & \\ L a = S a \times \frac{N {a}^{2}}{l} & ( 2 ) \\ [ Math . 3 ] & \\ L b = S b \times \frac{N {b}^{2}}{l} & ( 3 )\end{matrix}$$

M is the mutual inductance, k is a coupling coefficient, La is self-inductance of the primary coil 3, and Lb is self-inductance of the secondary coil 4. Sa is a cross-sectional area of the primary coil 3, Sb is a cross-sectional area of the secondary coil 4, Na is the number of turns of the primary coil 3, Nb is the number of turns of the secondary coil 4, and 1 is the distance between the primary coil 3 and the secondary coil 4.

As can be seen from the above-mentioned equations (1) to (3), transmission characteristics of the transformer are improved by increasing the mutual inductance. That is to say, by increasing the cross-sectional area and the number of turns of each of the coils and reducing the distance between the coils, the mutual inductance is increased, and the transmission characteristics of the transformer are improved.

FIG. 4 is a top plan view of a microtransformer element (hereinafter, referred to as a “related microtransformer element”) related to the microtransformer element according to Embodiment 1. Only the components of the primary coil 3 and the secondary coil 4 are illustrated in FIG. 4 as in FIG. 2.

In the related microtransformer element, the central axis of the plurality of primary partial coils 3a and the central axis of the plurality of secondary partial coils 4a are not located on the one straight line 5, and the central axis of one of the primary partial coils 3a and the secondary partial coils 4a is located outside the other one of the primary partial coils 3a and the secondary partial coils 4a. In this configuration, an ineffective region that cannot be used effectively between the primary partial coils 3a and the secondary partial coils 4a generally has an area represented by (the distance L1 between the primary partial coils 3a and the secondary partial coils 4a)×(the length of each of the primary partial coils 3a and the secondary partial coils 4a).

In contrast, in Embodiment 1, the central axis of the plurality of primary partial coils 3a and the central axis of the plurality of secondary partial coils 4a are located on the one straight line 5 as illustrated in FIG. 2. In this configuration, the ineffective region that cannot be used effectively between the primary partial coils 3a and the secondary partial coils 4a generally has an area represented by (the distance D1 between the primary partial coils 3a and the secondary partial coils 4a)×(the width of each of the primary partial coils 3a and the secondary partial coils 4a).

The above-mentioned distance D1 and the above-mentioned distance L1 are herein each typically set to a distance enabling securement of insulation (a breakdown voltage) between the primary partial coils 3a and the secondary partial coils 4a, and thus are substantially the same distance. On the other hand, the width of each of the primary partial coils 3a and the secondary partial coils 4a is typically smaller than the length of each of the primary partial coils 3a and the secondary partial coils 4a. The area of the ineffective region of the microtransformer element according to Embodiment 1 (=the distance D1×the width of each coil) can thus be smaller than the area of the ineffective region of the related microtransformer element (=the distance L1×the length of each coil).

Furthermore, in Embodiment 1, one or more of the primary partial coils 3a are each interposed between a pair of the secondary partial coils 4a in plan view, so that magnetic flux generated at opposite ends of the primary partial coil 3a along its length passes through the pair of secondary partial coils 4a. In addition, one or more of the secondary partial coils 4a are each interposed between a pair of the primary partial coils 3a in plan view, so that magnetic flux in the pair of primary partial coils 3a passes through the secondary partial coil 4a from opposite ends of the secondary partial coil 4a along its length. According to such a configuration, magnetic flux generated in the primary coil 3 can efficiently pass through the secondary coil 4, so that the coupling coefficient (k) in the equation (1) can be increased, and, as a result, the transmission characteristics can be increased. The size of the microtransformer element and a chip size can be reduced by reducing the number of turns and the cross-sectional area of each coil by the increase in coupling coefficient.

<Manufacturing Method>

FIGS. 5 to 10 are schematic perspective views for illustrating a method for manufacturing the microtransformer element according to Embodiment 1.

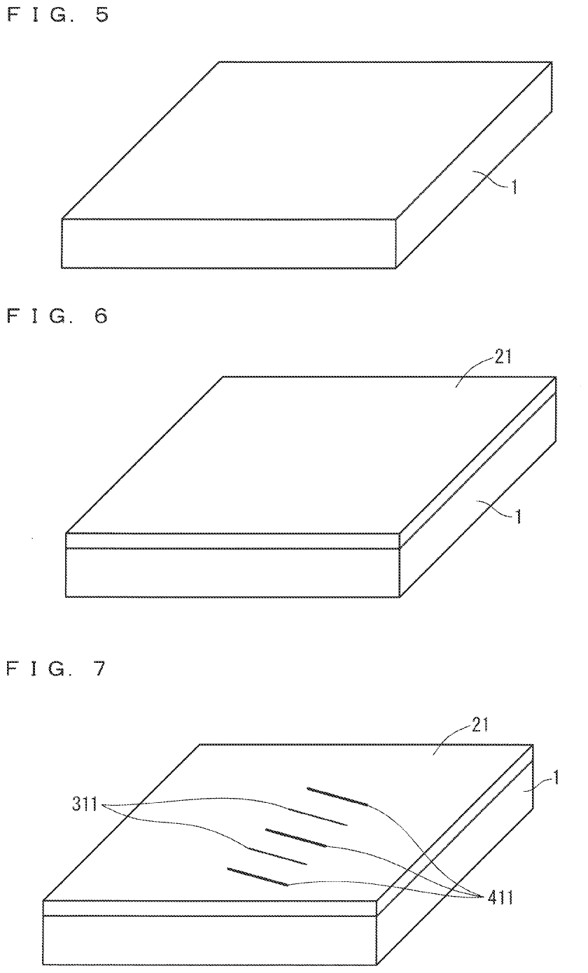

The substrate 1 is prepared first as illustrated in FIG. 5. A first insulating film 21 to be a portion of the insulating film 2 is then formed on the substrate 1, for example, by chemical vapor deposition (CVD) as illustrated in FIG. 6. The first insulating film 21 is only required to be a film that can electrically insulate the substrate 1 from the primary coil 3 and the secondary coil 4 at completion of the microtransformer element, and may be an oxide film, a nitride film, and the like, or may be any other insulating film, for example.

A first conductive film is then formed on the first insulating film 21, for example, by vacuum deposition, CVD, sputtering, and the like. The first conductive film may be a metal film of gold, aluminum, and the like, may be a low resistance conductive film, or may be a conductive organic film. The first conductive film is processed into a desired pattern using photoengraving technology and etching technology. By the processing, line portions 311 of the primary partial coils 3a on an XY plane parallel to the substrate 1 and line portions 411 of the secondary partial coils 4a on the XY plane parallel to the substrate 1 are formed from the first conductive film as illustrated in FIG. 7.

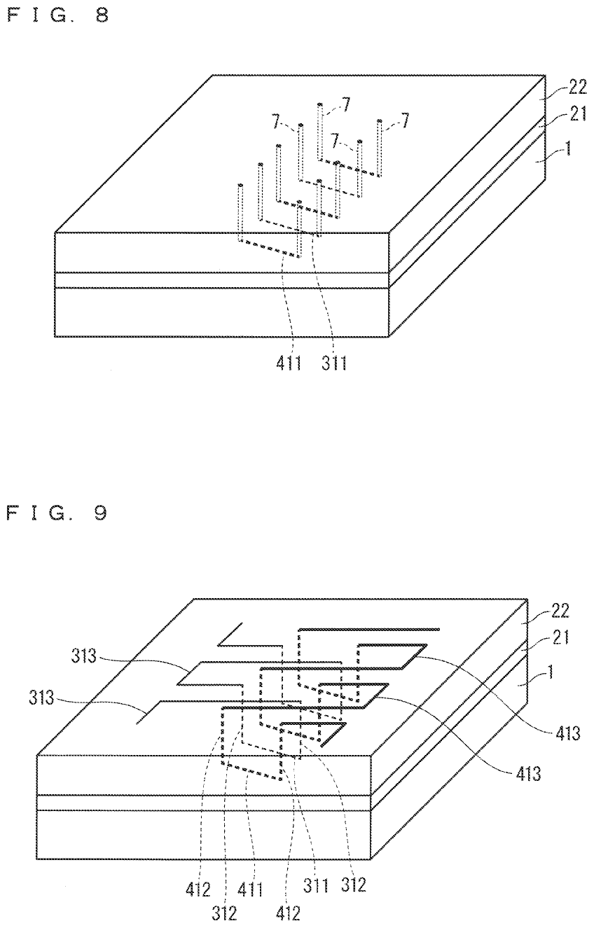

A second insulating film 22 to be a portion of the insulating film 2 is then formed on the first insulating film 21, the line portions 311, and the line portions 411 as with the first insulating film 21 as illustrated in FIG. 8. A plurality of holes 7 extending in a vertical direction (Z direction) and reaching the line portions 311 and the line portions 411 are then formed using photoengraving technology and etching technology for the second insulating film 22 as with a first conductive film.

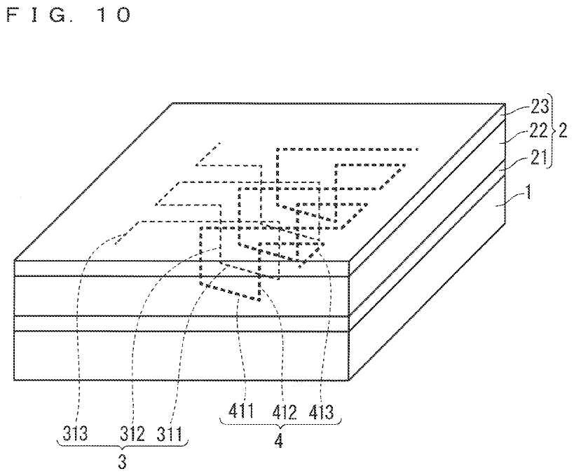

A second conductive film is then formed on the first insulating film 21 and in the plurality of holes 7 as with the first conductive film. Line portions 312 of the primary partial coils 3a in the Z direction and line portions 412 of the secondary partial coils 4a in the Z direction are thereby formed as illustrated in FIG. 9. Line portions 313 of the primary partial coils 3a on the XY plane parallel to the substrate 1 and line portions 413 of the secondary partial coils 4a on the XY plane parallel to the substrate 1 are then formed using photoengraving technology and etching technology for the second conductive film on the second insulating film 22 as with the first conductive film.

Patterns of the line portions 313 of the primary coil 3 and the line portions 413 of the secondary coil 4 may be processed in a step different from a step of forming the line portions 312 of the primary coil 3 and the line portions 412 of the secondary coil 4. For example, after the line portions 312 of the primary coil 3 and the line portions 412 of the secondary coil 4 are formed by forming the second conductive film only in the plurality of holes 7, a third conductive film connected to the line portions 312 and the line portions 412 may be formed on the second insulating film 22. The line portions 313 of the primary coil 3 and the line portions 413 of the secondary coil 4 may then be formed using photoengraving technology and etching technology for the third conductive film as with the first conductive film.

A third insulating film 23 to be a portion of the insulating film 2 is finally formed on the second insulating film 22, the line portions 313, and the line portions 413 as with the first insulating film 21 as illustrated in FIG. 10. The microtransformer element according to Embodiment 1 is formed as described above.

### Summary of Embodiment 1

According to the microtransformer element according to Embodiment 1 as described above, the central axis of the plurality of primary partial coils 3a and the central axis of the plurality of secondary partial coils 4a are located on the one straight line 5. According to such a configuration, the ineffective region can be reduced to thereby reduce the size of the microtransformer element and the chip size. Reduction in cost of the microtransformer element can thereby be expected.

Furthermore, in Embodiment 1, one or more of the primary partial coils 3a are each interposed between a pair of the secondary partial coils 4a, and one or more of the secondary partial coils 4a are each interposed between a pair of the primary partial coils 3a in plan view. According to such a configuration, the transmission characteristics can be increased to thereby increase the coupling coefficient (k). The size of the microtransformer element and the chip size can further be reduced by reducing the number of turns and the cross-sectional area of each coil by the increase in coupling coefficient.

<Modification 1>

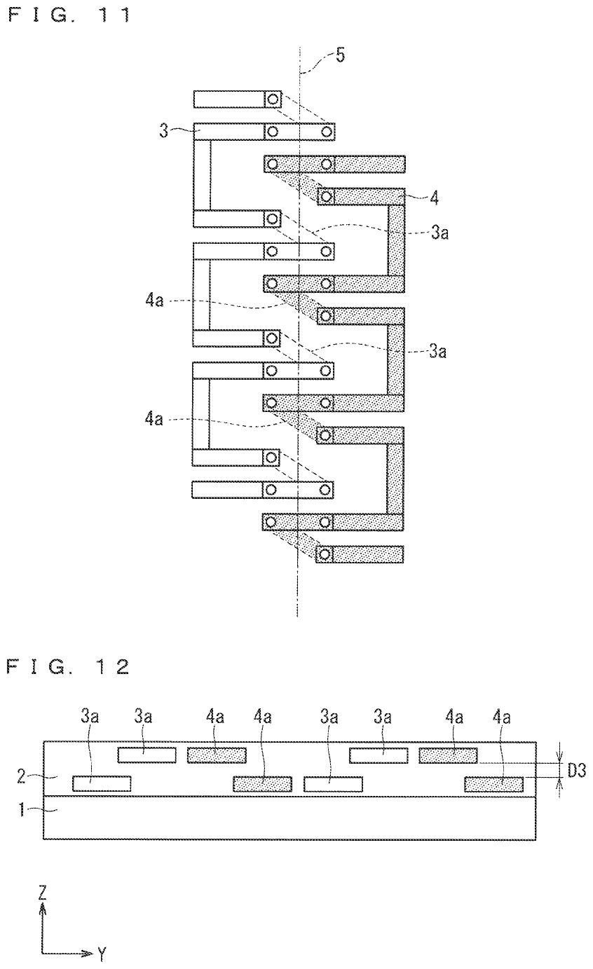

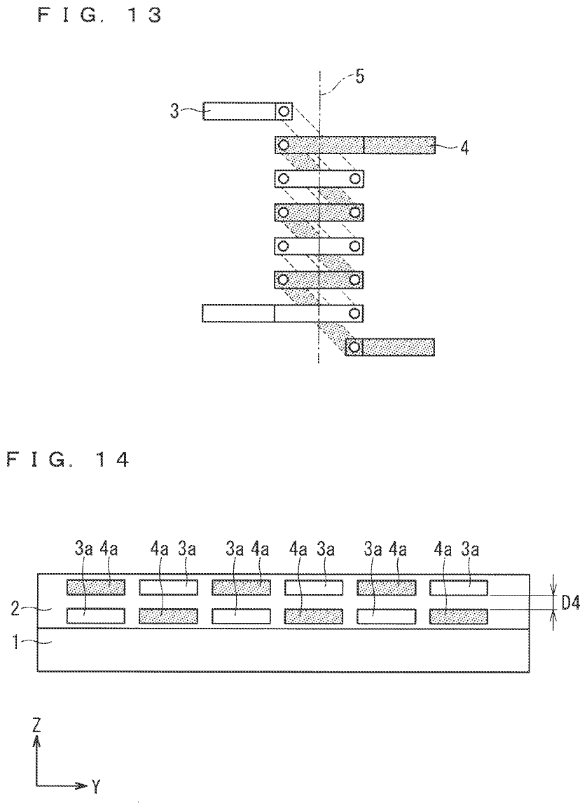

FIG. 11 is a top plan view of a microtransformer element according to Modification 1, and FIG. 12 is a cross-sectional view along the straight line 5 of FIG. 11. FIG. 13 is a top plan view of another microtransformer element according to Modification 1, and FIG. 14 is a cross-sectional view along the straight line 5 of FIG. 13.

As illustrated in FIGS. 11 to 14, in Modification 1, one or more of the primary partial coils 3a each being a single turn are each interposed between a pair of the secondary partial coils 4a each being a single turn, and one or more of the secondary partial coils 4a each being a single turn are each interposed between a pair of the primary partial coils 3a each being a single turn in plan view. According to such a configuration, when a voltage difference between the primary coil 3 and the secondary coil 4 is small, for example, a microtransformer having an increased coupling coefficient (k) and increased transmission efficiency while having a reduced chip size in plan view can be achieved.

In the configuration illustrated in FIG. 11, the primary partial coils 3a and the secondary partial coils 4a are spaced apart from each other in plan view. That is to say, the primary partial coils 3a and the secondary partial coils 4a are arranged not to face each other in the Z direction in FIG. 12. According to such a configuration, the distance between upper line portions of the primary partial coils 3a and the secondary partial coils 4a and lower line portions of the primary partial coils 3a and the secondary partial coils 4a is relatively large as illustrated in FIG. 12. Insulation (the breakdown voltage) between the primary partial coils 3a and the secondary partial coils 4a can thus be secured even if a thickness D3 is relatively small. As a result, ease of manufacture, reduction in manufacturing cost, and reduction in takt time can be expected.

On the other hand, in the configuration illustrated in FIG. 13, the primary partial coils 3a and the secondary partial coils 4a cross each other in plan view. That is to say, the primary partial coils 3a and the secondary partial coils 4a are arranged to face each other in the Z direction in FIG. 14. According to such a configuration, insulation (the breakdown voltage) between the primary partial coils 3a and the secondary partial coils 4a is dependent on a thickness D4. Thus, when the breakdown voltage between the primary partial coils 3a and the secondary partial coils 4a is required to be high, it is necessary to increase the thickness D4 to make manufacture somewhat difficult. According to the configuration illustrated in FIGS. 13 and 14, however, the chip size in plan view can be reduced compared with that in the configuration illustrated in FIGS. 11 and 12.

<Modification 2>

In Embodiment 1, one or more of the primary partial coils 3a are each interposed between a pair of the secondary partial coils 4a, and one or more of the secondary partial coils 4a are each interposed between a pair of the primary partial coils 3a in plan view, but the configuration of the primary partial coils 3a and the secondary partial coils 4a is not limited to this configuration. For example, the primary partial coils 3a and the secondary partial coils 4a may have a configuration in which one or more of the primary partial coils 3a are each interposed between a pair of the secondary partial coils 4a in plan view or a configuration in which one or more of the secondary partial coils 4a are each interposed between a pair of the primary partial coils 3a in plan view.

The same applies to Modification 1. That is to say, the primary partial coils 3a and the secondary partial coils 4a may have a configuration in which one or more of the primary partial coils 3a each being a single turn are each interposed between a pair of the secondary partial coils 4a each being a single turn in plan view or a configuration in which one or more of the secondary partial coils 4a each being a single turn are each interposed between a pair of the primary partial coils 3a each being a single turn in plan view.

Embodiments and Modifications can be modified and omitted as appropriate.

While the invention has been shown and described in detail, the foregoing description is in all aspects illustrative and not restrictive. It is therefore understood that numerous modifications and variations can be devised without departing from the scope of the invention.

What is claimed is:

1. A transformer element comprising:
a substrate;
an insulating film disposed on the substrate;
a primary coil including a plurality of primary partial coils arranged within the insulating film, the plurality of primary partial coils have a central axis located on one straight line in an in-plane direction of the insulating film; and
a secondary coil including a plurality of secondary partial coils arranged within the insulating film, the plurality of secondary partial coils have a central axis located on the one straight line, wherein
one or more of the primary partial coils are each interposed between a pair of the secondary partial coils, or one or more of the secondary partial coils are each interposed between a pair of the primary partial coils in plan view.

2. The transformer element according to claim 1, wherein
one or more of the primary partial coils are each interposed between a pair of the secondary partial coils, and one or more of the secondary partial coils are each interposed between a pair of the primary partial coils in plan view.

3. The transformer element according to claim 1, wherein
one or more of the primary partial coils each comprising a single turn are each interposed between a pair of the secondary partial coils each comprising a single turn, or one or more of the secondary partial coils each comprising a single turn are each interposed between a pair of the primary partial coils each comprising a single turn in plan view.

4. The transformer element according to claim 1, wherein
the primary partial coils and the secondary partial coils are spaced apart from each other in plan view.
